(19) United States
(12) Patent Application Publication
(10) Pub. No.: US 2016/0031418 A1
(43) Pub. Date: Feb. 4, 2016

(54) KEYLESS UNLOCKING SYSTEM AND KEYLESS UNLOCKING METHOD FOR VEHICLES

(71) Applicant: HON HAI PRECISION INDUSTRY CO., LTD., New Taipei (TW)

(72) Inventor: CHIH-CHUNG WENG, New Taipei (TW)

(73) Assignee: HON HAI PRECISION INDUSTRY CO., LTD., New Taipei (TW)

(21) Appl. No.: 14/550,617

(22) Filed: Nov. 21, 2014

(30) Foreign Application Priority Data
Jul. 30, 2014 (TW) 103125947

(51) Int. Cl. B60R 25/25; H04N 5/225; H04N 7/18

(52) U.S. Cl. CPC B60R 25/25; H04N 7/18; H04N 5/2252

(57) ABSTRACT

A keyless unlocking system includes an image capturing module, an image processing module electrically connected to the image capturing module, and a control module electrically connected to the image processing module. The image capturing module is configured to get real-time information of a user and feedback the real-time information to the image processing module. The image processing module includes a memory and a central processing unit. The memory pre-stores the unlocking information input by the user or by vehicle manufacturers. The memory also stores the real-time information of the user from the image capturing module. The central processing unit analyzes whether the real-time information matches the unlocking information and feedbacks an analyzed result to the control module. The control module operates according to the analyzed result.

### FIELD

The subject matter herein generally relates to a vehicle which can be safely unlocked without keys, and more specifically to a keyless unlocking system and method for vehicles.

### BACKGROUND

Vehicles have become a basic transportation tool for many people. An increasing number of vehicle thefts require more attention to anti-theft devices.

Most unlocking systems use a mechanical lock or a smart key with a wireless transceiver, such as Radio Frequency Identification (RFID). These unlocking technologies depend on a verification between a key and a lock, meaning anyone who controls the key can also unlock the lock.

### BRIEF DESCRIPTION OF THE DRAWINGS

Implementations of the present technology will now be described, by way of example only, with reference to the attached figures.

FIG. 1 is a diagrammatic view of a vehicle.

FIG. 2 is a diagrammatic view of a keyless unlocking system.

FIG. 3 is a flow diagram illustrating a keyless unlocking method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a vehicle which can be safely unlocked without any keys, a keyless unlocking system for the vehicle and a keyless unlocking method.

A vehicle includes a door, a lock unit and a keyless unlocking system. The keyless unlocking system comprises an image capturing module mounted on the door, an image processing module electrically connected to the image capturing module, and a control module electrically connected to the image processing module. The image capturing module is configured to get real-time information of a user and feedback the real-time information to the image processing module. The image processing module comprises a memory and a central processing unit electrically connected to the memory. The memory can pre-store the unlocking information input by the user or by vehicle manufacturers. The memory can also store the real-time information of the user from the image capturing module. The central processing unit analyzes whether the unlocking information matches the real-time information and feedbacks an analyzed result to the control module. When the unlocking information matches the real-time information, the control module controls the lock unit to unlock the door.

A keyless unlocking system comprises an image capturing module, an image processing module electrically connected to the image capturing module, and a control module electrically connected to the image processing module. The image capturing module is configured to get real-time information of a user and feedback the real-time information to the image processing module. The image processing module comprises a memory and a central processing unit electrically connected to the memory. The memory can pre-store the unlocking information input by the user or by vehicle manufacturers. The memory can also store the real-time information of the user from the image capturing module. The central processing unit analyzes whether the real-time information matches the unlocking information and feedbacks an analyzed result to the control module. The control module operates according to the analyzed result.

A keyless unlocking method of the vehicle comprises, providing a vehicle which includes a door, a lock unit and a keyless unlocking system. The keyless unlocking system includes an image capturing module mounted on the door, an image processing module electrically connected to the image capturing module, and a control module electrically connected to the image processing module, and pre-storing unlocking information in the image processing module. Scanning and capturing the real-time information by the image capturing module and transmitting the real-time information to the image processing module. The image processing module analyzes whether the unlocking information matches the real-time information and feedbacks an analyzed result to the control module. When the unlocking information matches the real-time information, the control module controls the lock unit to unlock the door.

In some embodiments, an image capturing module is configured to receive outside image information, and a memory is configured to collect and store both outside image information and unlocking information. An image processing module is configured to verify whether the outside image information matches the unlocking information and then feedbacks an analyzed result to a control module to unlock a security system or activate an alarm device in case of a lost key or dead battery in the key. Furthermore, because the image processing module needs to verify whether the outside image information matches the unlocking information, this method provides high security level and anti-theft performance for the vehicle.

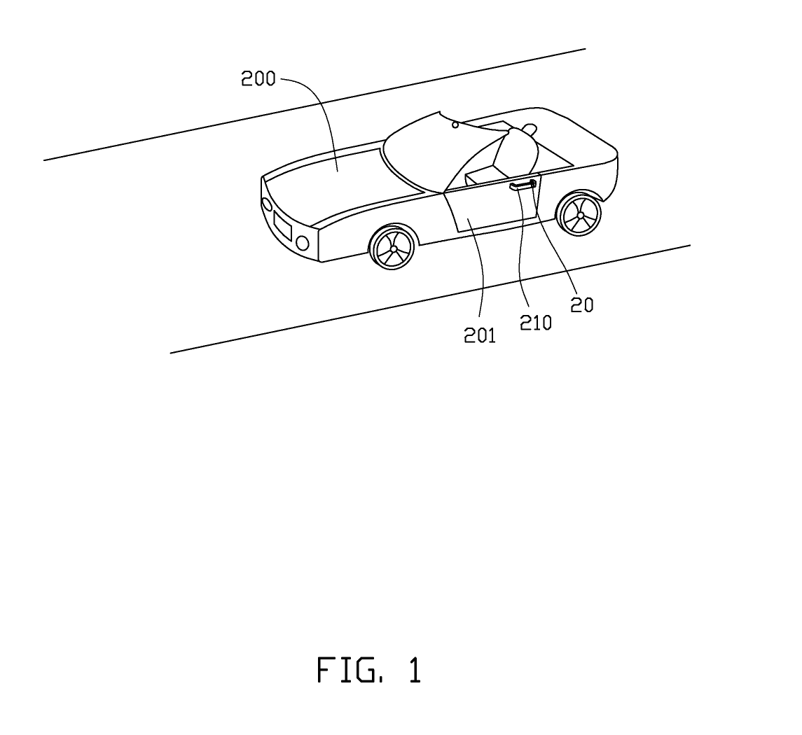

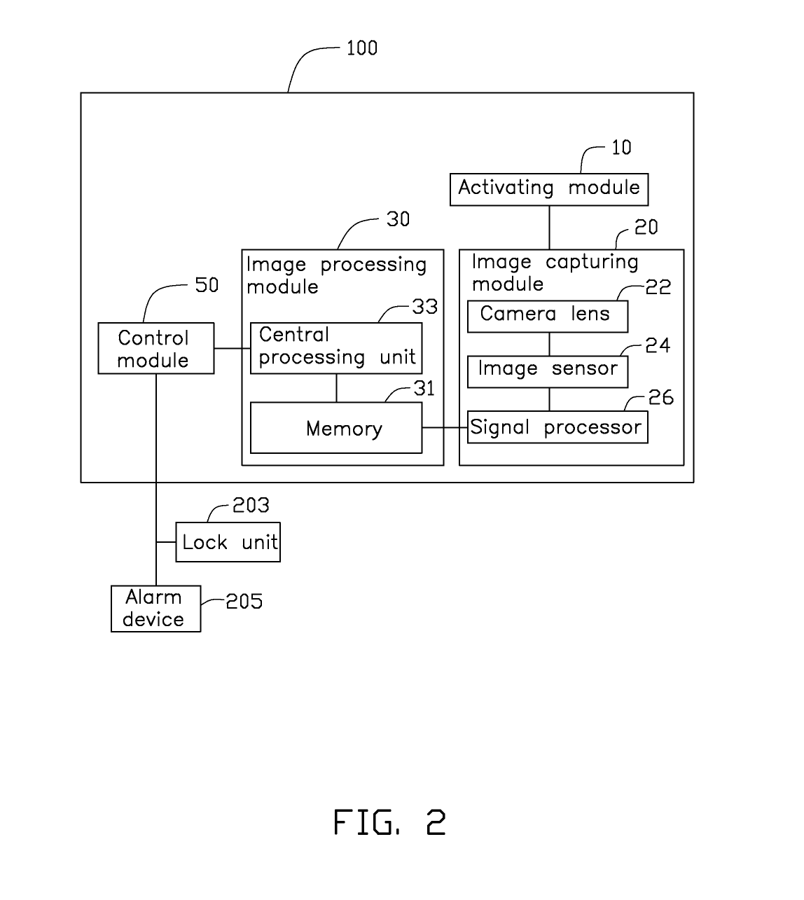

FIG. 1 and FIG. 2 illustrate an embodiment of a vehicle 200 which comprise a keyless unlocking system 100, a door 201, a lock unit 203, and an alarm device 205. A door handle 210 is mounted on the door 201.

The keyless unlocking system 100 comprises an activating module 10, a image capturing module 20 electrically connected to the activating module 10, an image processing module 30 electrically connected to the image capturing module 20, and a control module 50 electrically connected to the image processing module 30. The activating module 10 and the image capturing module 20 are both set in the door handle 210. The image processing module 30 and the control module 50 are both set inside the vehicle 200.

The activating module 10 is configured to activate the image capturing module 20 in the keyless unlocking system 100. According to this embodiment, the activating module 10 includes an infra-red sensor or a microwave sensor which is set in the door handle 210. When someone is near the door 201 or pulls the door handle 210 to open the door 201, the activating module 10 starts to activate the image capturing module 20.

In the embodiment, the image capturing module 20 is set in the door handle 210 as shown in FIG. 1. The image capturing module 20 comprises a camera lens 22 electrically connected to the activating module 10, an image sensor 24 electrically connect to the camera lens 22, a signal processor 26 electrically connect to the image sensor 24. The camera lens 22 is configured to scan a user (such as a driver, a passenger or anyone who wants to unlock the keyless unlocking system 100) to get real-time information of the user and transform the real-time information to be an optical signal. The real-time information includes body features (for example, fingerprints, facial information or pulse information) or body movements (for example, hand gestures, leg gestures, or eye movement). The image sensor 24 is configured to convert an optical signal from the camera lens 22 to an electrical signal. The signal processor 26 is configured to implement a signal processing for the electrical signal within the real-time information.

In the embodiment, the image capturing module 20 can be a camera, a fingerprint scanner, thermal image sensor module or a biological sensor module.

In the embodiment, the image capturing module 20 can further comprise auxiliary devices, such as a lighting device or night vision device. For example, the lighting device provides a bright environment for the camera lens 22 to scan the user and collect the real-time information easily.

The image processing module 30 is electrically connected to the image capturing module 20. The image processing module 30 comprises a memory 31 and a central processing unit 33. The memory 31 and the central processing unit 33 are set inside the vehicle 200. The memory 31 is electrically connected to the signal processor 26. The memory 31 can pre-store unlocking information input by the user or by vehicle companies. The unlocking information comprises body features (for example, fingerprints, facial information or pulse information) or body movements (for example, hand gestures, leg gestures, or eye movement). The memory 31 also can store real-time information while the user is trying to unlock the door 201. The real-time information comprises body features (for example, fingerprints, facial information or pulse information) or body movements (for example, hand gestures, leg gestures, or eye movements) from the image capturing module 20.

The central processing unit 33 can analyze and verify whether the real-time information matches the unlocking information by comparing the real-time information from the user who is trying to unlock the door 201 with the unlocking information pre-stored in the image processing module 30.

The control module 50 is coupled to the central processing unit 33, the lock unit 203 and the alarm device 205. The central processing unit 33 feedbacks a positive analyzed result to the control module 50, when the real-time information matches the unlocking information. The control module 50 determines the positive analyzed result as an unlocking signal and then controls the lock unit 203 to unlock the door 201. The central processing unit 33 feedbacks a negative analyzed result to the control module 50, when the real-time information does not match the unlocking information. The control module 50 indentifies the negative analyzed result as a locking signal and controls the lock unit 203 to remain locked. In the meantime, the alarm device 205 is activated for security.

In some embodiments, the activating module 10 is not necessary in the keyless unlocking system 100, as long as the image capturing module 20 can stay in working condition to continuously receive the real-time information.

As a example of the keyless unlocking system 100 working. A user pre-stores fingerprint information as unlocking information in the vehicle 200. When the user wants to unlock the door 201, the image capturing module 20 scans the fingerprint information of the user and then transmits the fingerprint information to the image processing module 30. The central processing unit 33 in the image processing module 30 analyzes whether the pre-stored fingerprint information matches the fingerprint information of the user. When the pre-stored fingerprint information matches the fingerprint information of the user, the central processing unit 33 feedbacks an unlock signal to the control module 50. The control module 50 then controls the lock unit 203 to unlock the door 201.

On the other hand, when a stranger wants to unlock the door 201, the image capturing module 20 scans and collects the fingerprint information of the stranger and then transmits the fingerprint information of the stranger to the image processing module 30. The central processing unit 33 analyzes whether the pre-stored fingerprint information matches the fingerprint information of the stranger. Because the pre-stored fingerprint information does not match the fingerprint information of the stranger, the central processing unit 33 feedbacks a lock signal to the control module 50. The control module 50 controls the lock unit 203 to keep the door 201 locked. In the meantime, the alarm device 205 is activated for security.

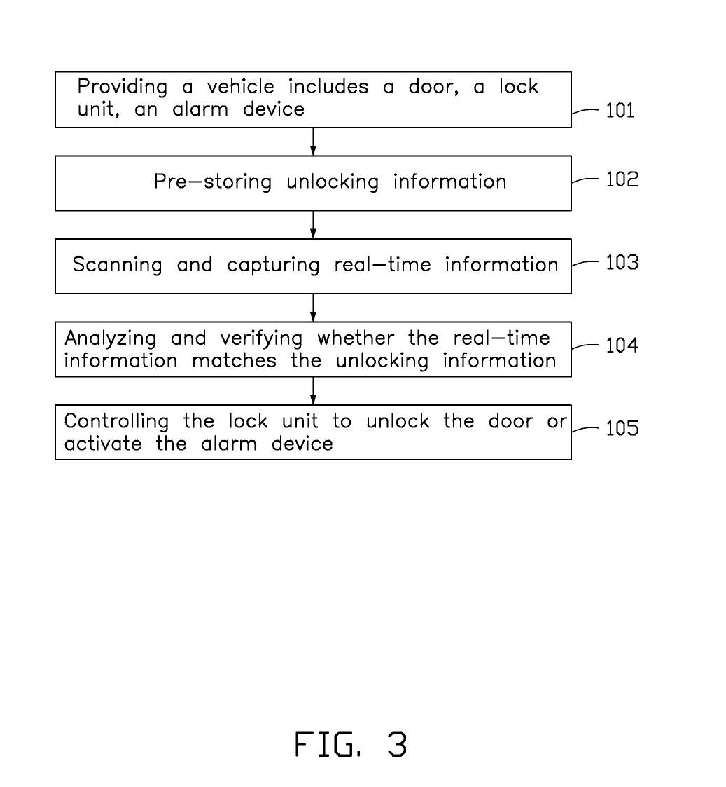

FIG. 3 illustrates one embodiment of a keyless unlocking method. In the embodiment the keyless unlocking method can be implemented in reference to the vehicle 200 and the keyless unlocking system 100.

In block 101, a vehicle 200 is provided including a door 201, a lock unit 203 an alarm device 205 and a keyless unlocking system 100. The keyless unlocking system 100 includes an activating module 10, an image capturing module 20 electrically connected to the activating module 10, an image processing module 30 electrically connected to the image capturing module 20, and a control module 50 electrically connected to the image processing module 30.

In block 102, the unlocking information is pre-stored in the memory 31. According to this embodiment, the memory 31 can pre-store unlocking information. The unlocking information includes body features (for example, fingerprints, facial information or pulse information) or body movements (for example, hand gestures, leg gestures, or eye movement) of a user.

In block 103, the real-time information is scanned and captured by the image capturing module 20. In the embodiment, the image capturing module 20 is configured to get real-time information, such as fingerprints, facial information, or pulse information of a user. Then the image sensor 24 is configured to send the real-time information to the signal processor 26. The signal processor 26 is configured to manipulate the real-time information.

In block 104, analyzing and verifying whether the real-time information matches the unlocking information. The central processing unit 33 is configured to analyze the real-time information and the unlocking information.

In block 105, the keyless unlocking system 100 is controlled to unlock the door 201 or activate the alarm device 205. When the real-time information matches the unlocking information, the control module 50 sends an unlocking signal to the lock unit 203 and unlocks the door 201. When the real-time information does not match the unlocking information, the control module 50 sends a lock signal to the lock unit 203 and the door 201 remains locked. In the meantime, the control module 50 also activates the alarm device 205.

The embodiments shown and described above are only examples. Many details are often found in the art such as the other features of a vehicle multimedia system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A vehicle comprising:
a door;
a lock unit; and
a keyless unlocking system in the vehicle comprising:
an image capturing module configured to get real-time information of a user;
a control module configured to control the lock unit; and
an image processing module electrically connected to the image capturing module having a memory and a central processing unit electrically connected to the memory, wherein
the memory pre-stores unlocking information;
the memory stores the real-time information from the image capturing module;
the central processing unit analyzes whether the unlocking information matches the real-time information and feedbacks an analyzed result to the control module; and
when the unlocking information matches the real-time information, the control module controls the lock unit to unlock the door.

2. The vehicle of claim 1, wherein the image capturing module is mounted on the door.

3. The vehicle of claim 1, wherein the keyless unlocking system comprises an activating module electrically connected to the image capturing module for activating the image capturing module when someone is near the door.

4. The vehicle of claim 3, wherein the image capturing module comprises:
a camera lens electrically connected to the activating module;
an image sensor electrically connected to the camera lens; and
a signal processor electrically connected to the image sensor, wherein
the camera lens is configured to get the real-time information and transform the real-time information to be an optical signal;
the image sensor is configured to convert the optical signal from the camera lens to an electrical signal; and
the signal processor is configured to implement a signal processing for the electrical signal within the real-time information from the image sensor.

5. The vehicle of claim 1, wherein the unlocking information and the real-time information comprise body features.

6. The vehicle of claim 1, wherein the unlocking information and real-time information comprise body movements.

7. The vehicle of claim 5, wherein the body features comprise fingerprints, facial information or pulse information.

8. The vehicle of claim 6, wherein the body movements comprise hand gestures, leg gestures, or eye movement.

9. The vehicle of claim 4, wherein the camera lens is set in a door handle of the vehicle.

10. The vehicle of claim 1, wherein the vehicle comprises an alarm device electrically connected to the control module; and
when the unlocking information does not match the real-time information, the control module activates the alarm device.

11. The vehicle of claim 1, wherein the image capturing module further comprises a lighting device.

12. A keyless unlocking system comprising:
an image capturing module configured to get real-time information of a user;
a control module; and
an image processing module electrically connected to the image capturing module having a memory and a central processing unit electrically connected to the memory, wherein
the memory pre-stores unlocking information;
the memory stores the real-time information from the image capturing module; and
the central processing unit analyzes whether the unlocking information matches the real-time information and feedbacks an analyzed result to the control module.

13. The keyless unlocking system of claim 12, wherein the keyless unlocking system comprises an activating module electrically connected to the image capturing module for activating the image capturing module when someone is close to the door.

14. The keyless unlocking system of claim 13, wherein the image capturing module comprises:
a camera lens electrically connected to the activating module;
an image sensor electrically connected to the camera lens; and
a signal processor electrically connected to the image sensor, wherein
the camera lens is configured to capture the real-time information and transform the real-time information to be an optical signal;
the image sensor is configured to convert the optical signal from the camera lens to an electrical signal; and
the signal processor is configured to implement a signal processing for the electrical signal including the real-time information from the image sensor.

15. The keyless unlocking system of claim 12, wherein the unlocking information and the real-time information comprise body features.

16. The keyless unlocking system of claim 12, wherein the unlocking information and the real-time information comprise body movements.

17. The keyless unlocking system of claim 15, wherein the body features comprise fingerprints, facial information or pulse information.

18. The keyless unlocking system of claim 16, wherein the body movements comprise hand gestures, leg gestures or eye balls movement.

19. The keyless unlocking system of claim 12, wherein the image capturing module further comprises a lighting device.

20. A method of unlocking a keyless vehicle, the method comprising:
providing a vehicle which includes a door, a lock unit, an alarm device and a keyless unlocking system, wherein the keyless unlocking system further comprises an image capturing module, an image processing module electrically connected to the image capturing module, and a control module electrically connected to the image processing module;
pre-storing unlocking information in the image processing module;
Scanning and capturing real-time information by the image capturing module;
analyzing and verifying whether the real-time information matches the unlocking information; and
controlling the lock unit to unlock the door when the unlocking information matches the real-time information; and activate the alarm device when the unlocking information do not match the real-time information.
